(19) United States
(12) Patent Application Publication
(10) Pub. No.: US 2022/0144331 A1
(43) Pub. Date: May 12, 2022

(54) INFORMATION INDICATING DEVICE, INFORMATION INDICATING METHOD, AND COMPUTER READABLE MEDIUM

(71) Applicant: MITSUBISHI ELECTRIC CORPORATION, Tokyo (JP)

(72) Inventors: Takashi OTA, Tokyo (JP); Michinori YOSHIDA, Tokyo (JP)

(73) Assignee: MITSUBISHI ELECTRIC CORPORATION, Tokyo (JP)

(21) Appl. No.: 17/583,807

(22) Filed: Jan. 25, 2022

Related U.S. Application Data
(63) Continuation of application No. PCT/JP2019/035660, filed on Sep. 11, 2019.

(51) Int. Cl. B62D 1/04; B62D 15/02; B60W 50/16; B60W 30/095

(52) U.S. Cl. CPC B62D 1/046; B62D 15/029; B60W 2540/223; B60W 30/0956; B60W 50/16

(57) ABSTRACT

An information indicating device (103) includes: a grip detection unit (340) to determine a part of a palm and the like by which a driver grips a steering wheel (200), based on grip detection information regarding a contact state between a mobile object (100) the driver and the steering wheel (200), and based on pattern information indicating a contact pattern between the steering wheel (200) and the palm and the like, and generate grip information including information on the part of the palm and the like; and a stimulus generation unit (350) to, when there is a possibility that the mobile object (100) contacts with an obstacle that is located around the mobile object (100), generate based on the grip information, stimulus information that leads the driver to avoid the obstacle.

### CROSS REFERENCE TO RELATED APPLICATION

This application is a Continuation of PCT International Application No. PCT/JP2019/035660, filed on Sep. 11, 2019, which is hereby expressly incorporated by reference into the present application.

### TECHNICAL FIELD

The present invention relates to an information indicating device, an information indicating method, and an information indicating program.

### BACKGROUND ART

In recent years, because of increased safety awareness, an automobile equipped with a driving support function such as a collision avoiding system or an approach warning system has become common. These systems transmit information to a driver mainly by sound. When the information is transmitted by the sound, it is possible to transmit severity of danger to the driver by strength of the sound, a ringing pattern, and the like, but it is impossible to transmit information such as what type of danger it is and which direction the danger is in. Further, careless warning by the sound may cause the driver to be confused and tensed.

Instead of the sound, there is also a method of indicating visual information by installing a warning light on an instrument panel. However, when this method is adopted, the driver needs to look away from the front in order to check the information, and therefore, the driver has lack of attention to the front.

Patent Literature 1 suggests a technique in which information on an environment around a vehicle is indicated to the driver by tactile sensation when the vehicle is driven, in such a manner that a tactile indicating device is installed in a steering wheel as a means of indicating the information.

Patent literature 1 discloses a technique in which when an object gets closer to the own vehicle, information is indicated, which regards directions such as a direction of the object, a direction in which the own vehicle should travel, and the like, to the driver in such a manner that a tactile sensation indicating device installed on a circumference of the steering wheel generates a specific pattern of a stimulus such as vibration of the steering wheel.

### CITATION LIST

### Patent Literature

Patent Literature 1: JP2010-018204A

### SUMMARY OF INVENTION

### Technical Problem

However, the technique of Patent Literature 1 needs to determine based on a grip area whether a grip hand is left or right, and

the driver needs to grip designated positions of a steering wheel by each of left and right hands so that the driver receives information such as a direction of a subject.

Thus, in a case where the grip areas of the left and right hands are switched at a time of turning left or right or in a case where there is a driver-specific habit in a gripping method, because there are some cases where a result of determining whether the grip hand is left or right is sometimes reversed, or where it is impossible to recognize that the driver grips the steering wheel, or so on, in this case, there are some cases where the stimulus information corresponding to a stimulus that the tactile sensation indicating device indicates to the driver, cannot be properly generated.

Therefore, in the technique of Patent Literature 1, there is a problem that the stimulus information that transfers information to the driver cannot be properly generated unless the driver grips a limited area of the steering wheel by a specified hand.

The present invention aims to generate the stimulus information, which transmits information to a driver properly regardless of an area which the driver grips on the steering wheel and a hand by which the driver grips the steering wheel, which is stimulus information that a tactile indicating device installed in the steering wheel can use.

### Solution to Problem

An information indicating device according to the present invention, transmitting stimulus information to a steering wheel of a mobile object including the steering wheel that indicates information to a driver based on the stimulus information corresponding to a stimulus, includes:

a grip detection unit to

receive from the steering wheel, grip detection information regarding a contact state between the driver and the steering wheel,

receive pattern information from a pattern database that stores the pattern information indicating a contact pattern between the steering wheel and a palm and the like when a human grips the steering wheel, and

determine a part of the palm and the like by which the driver grips the steering wheel, based on the grip detection information and the pattern information, and generate grip information including information on the part of the palm and the like; and

a stimulus generation unit to, when there is a possibility that the mobile object contacts with an obstacle that is located around the mobile object, generate based on the grip information, the stimulus information that leads the driver to avoid the obstacle by stimulating the palm and the like.

### Advantageous Effects of Invention

According to an information indicating device of the present invention,

a grip detection unit generates grip information based on grip detection information received from a grip detection sensor that a steering wheel includes, and pattern information received from a pattern database, and

in such a manner that a stimulus generation unit generates stimulus information based on the grip information,

the stimulus generation unit can generate the stimulus information, which transmits information to a driver properly regardless of an area which the driver grips on the steering wheel and a hand by which the driver grips the steering wheel, which is stimulus information that a tactile indicating device installed in the steering wheel can use.

### BRIEF DESCRIPTION OF DRAWINGS

FIG. 1 is a configuration diagram of a mobile object 100 including an information indicating device 103 according to first and second embodiments.

FIG. 2 is a configuration diagram of a steering wheel 200 that the mobile object 100 includes, (a) is a front view of the steering wheel 200, and (b) is a A-A cross sectional view of the steering wheel 200 illustrated in (a).

FIG. 3 is an example of installing an environment detection sensor 101 in the mobile object 100.

FIG. 4 is a configuration diagram of the information indicating device 103 according to the first embodiment.

FIG. 5 is a configuration diagram of a stimulus generation unit 350 according to the first embodiment.

FIG. 6 is a hardware configuration diagram of the information indicating device 103 according to the first embodiment.

FIG. 7 is a flowchart illustrating operation of the information indicating device 103 according to the first embodiment.

FIG. 8 is a diagram illustrating an example of pattern information, (a) is an intensity distribution on a driver's palm and the like, (b) is an intensity distribution on the steering wheel 200, and (c) is an image of an unfolded steering wheel 200 illustrated in (b).

FIG. 9 is a diagram illustrating input/output data of a grip detection unit 340 in a grip detection process.

FIG. 10 is a flowchart illustrating operation of the grip detection unit 340 according to the first embodiment.

FIG. 11 is a diagram illustrating an example of stimulus information which the stimulus generation unit 350 generates, according to the first embodiment, (a) is a graph for explaining a right turn pattern, (b) is a graph for explaining a left turn pattern, and (C) is a diagram illustrating stimulation positions.

FIG. 12 is a flowchart illustrating operation of the stimulus generation unit 350 according to the first embodiment.

FIG. 13 is an image in a case where the mobile object 100 goes out of a lane and the mobile object 100 and another vehicle are expected to contact with each other.

FIG. 14 is an image in a case where the mobile object 100 moves to another lane and the mobile object 100 and another vehicle are expected to contact with each other.

FIG. 15 is a flowchart illustrating operation of a modification example according to the first embodiment.

FIG. 16 is a configuration diagram of an information indicating device 103 according to a second embodiment.

FIG. 17 is a flowchart illustrating operation of the information indicating device 103 according to the second embodiment.

FIG. 18 is a diagram for explaining stimulus information which a stimulus generation unit 360 generates, according to the second embodiment, (a) is a diagram illustrating orientations around a mobile object 100, (b) is a diagram illustrating correspondence between a right hand and the orientations, and (c) is a diagram illustrating correspondence between a left hand and the orientations.

FIG. 19 is a diagram illustrating the stimulus information which the stimulus generation unit 360 generates, according to the second embodiment, (a) is a diagram illustrating orientations around the mobile object 100, and (b) is a diagram illustrating correspondence between a right hand and the orientations.

FIG. 20 is a diagram illustrating an example of the stimulus information which the stimulus generation unit 360 generates, according to the second embodiment, (a) is a graph for explaining a stimulus pattern 1, (b) is a graph for explaining a stimulus pattern 2, and (c) is a diagram illustrating a stimulation position.

FIG. 21 is a diagram illustrating an image in which an obstacle located in a driver's blind spot approaches the mobile object 100.

FIG. 22 is a diagram illustrating an image in which an obstacle located in a driver's blind spot approaches the mobile object 100.

### DESCRIPTION OF EMBODIMENTS

### First Embodiment

Below, as for the present embodiment, details will be described with reference to the drawings.

***Description of Configuration***

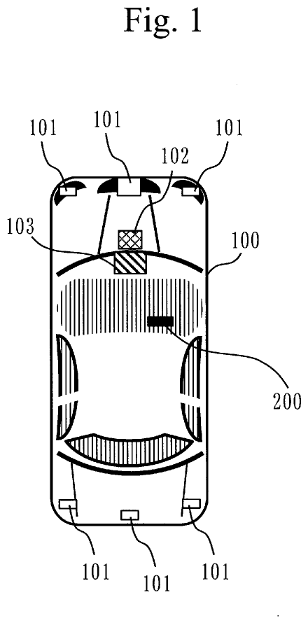

FIG. 1 is a diagram illustrating a configuration example of a mobile object 100 installed with an information indicating device 103 according to the present embodiment.

As illustrated in the present drawing, the mobile object 100 is installed with an environment detection sensor 101, a state detection sensor 102, the information indicating device 103, and a steering wheel 200.

The mobile object 100 is typically a vehicle, but the mobile object 100 may be an arbitrary object, for which human needs to control a direction at a time of moving, such as a ship or an airplane.

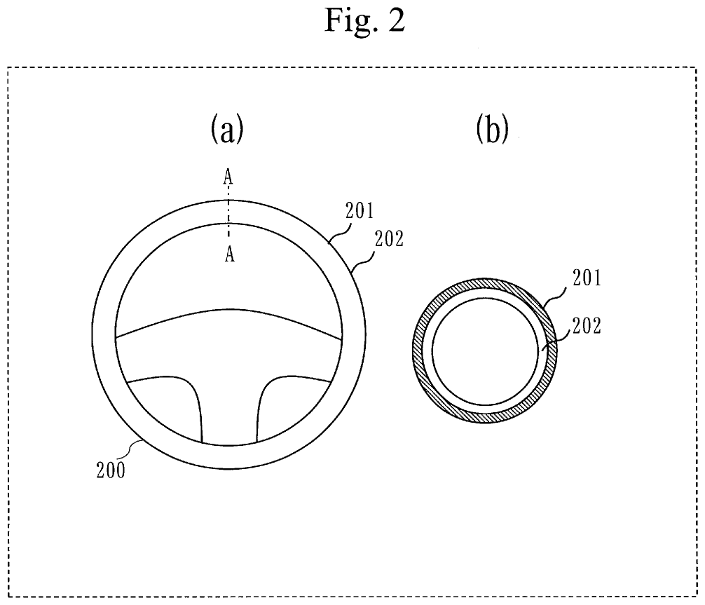

FIG. 2 is a diagram illustrating a configuration example of the steering wheel 200.

A left side of the present drawing illustrates a typical example of the steering wheel 200, and a right side illustrates a cross sectional view of a BA sectional surface of the steering wheel 200.

As illustrated in the present drawing, the steering wheel 200 has a tactile sensation indicating device 201 and a grip detection sensor 202.

A shape of the steering wheel 200 is typically an oval shape, but may be a different shape.

A surface of a normal grip unit of the steering wheel 200 is covered with the tactile sensation indicating device 201 so that one part of a palm and the like is contacted with the tactile sensation indicating device 201 no matter which part of the normal grip unit the driver grips.

The normal grip unit is

a part, in the steering wheel 200, which the driver usually grips when the driver controls a direction of the mobile object 100, and

is an outer circumference part of the steering wheel 200 when the steering wheel 200 is an oval shape.

Direction control of the mobile object 100 includes keeping the mobile object 100 moving in a forward direction.

The tactile sensation indicating device 201 is a device that transmits information, by giving a stimulus to a palm and the like of a driver, to the driver via tactile sensation of the palm and the like.

As a specific example, the tactile sensation indicating device 201 gives an electric stimulus to the driver by using an electrode. In the present example, the tactile sensation indicating device 201 typically leads the driver to avoid an obstacle by outputting the electric stimulus to the palm and the like by using the electrode on a place which is corresponding to a signal from a tactile sensation indicating process unit (not illustrated). At this time, the tactile sensation indicating device 201 adjusts intensity of the electric stimulus and a stimulus position. Note that, in a second embodiment, the tactile sensation indicating device 201 transmits a position and a threat of the obstacle to the driver.

The tactile sensation indicating device 201 may be something that gives a tactile sensation stimulus to the palm and the like by ultrasound, something that has a built-in device which stimulates a specific position of the palm and the like in such a manner that a part of the built-in device physically moves, something that gives the tactile sensation stimulus to the palm and the like by another method, or something that gives a plurality of types of stimuli to the palm and the like.

The environment detection sensor 101

detects environment information indicating an environment in surroundings of the mobile object 100,

is a sensor group for detecting an obstacle, a pedestrian, a vehicle, and the like, and

may be constituted of a plurality of types of sensors.

As a specific example, the environment information includes information on a distance between the mobile object 100 and an object that exists around the mobile object 100, and image information on the surroundings of the mobile object 100.

The number of sensors that constitute the environment detection sensor 101 may be arbitrary.

The sensors that constitute the environment detection sensor 101

may be arbitrary sensors that can acquire the information on the surroundings of the mobile object 100, and

as specific examples, are: sensors that measure a distance to an object, such as LiDAR (Light Detection And Ranging), millimeter wave radar, sonar, or the like; sensors that acquire a surrounding environment as an image, such as a camera; or the like.

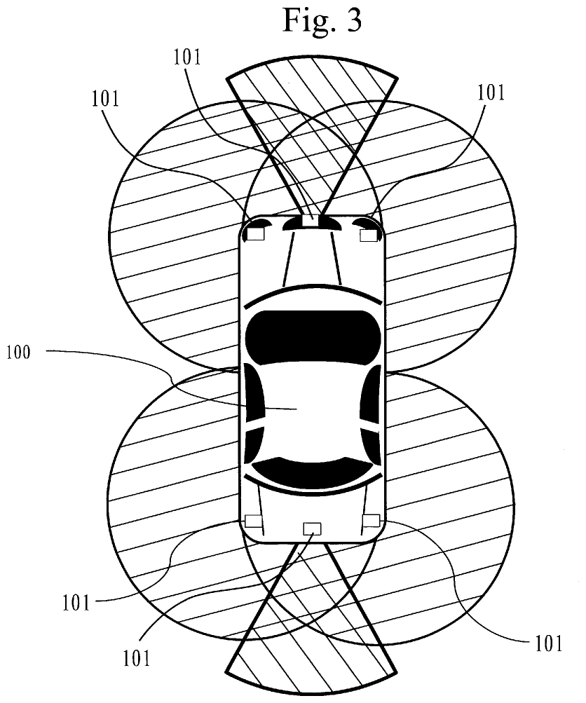

FIG. 3 is a diagram illustrating an example of installing the environment detection sensor 101 in the mobile object 100.

In the present drawing, four environment detection sensors 101 are mounted on a front part, a rear part, and four corners of the mobile object 100, and the present drawing illustrates by some parts of circles, a situation where these environment detection sensors 101 acquire information on the surroundings of the mobile object 100.

The state detection sensor 102

detects mobile object information indicating a state of the mobile object 100,

is a sensor group for acquiring the state of the mobile object 100 such as speed, acceleration, a steering angle, and/or the like of the mobile object 100, and

may be constituted of a plurality of types of sensors.

The number of sensors that constitute the state detection sensor 102 may be arbitrary.

As specific examples, the mobile object information includes the speed, the acceleration, turning speed, and the steering angle of the mobile object 100.

As specific examples, sensors that constitute the state detection sensor 102 are:

sensors that can acquire a movement state of the mobile object 100 such as GPS (Global Positioning System), INS (Inertial Navigation System), or the like; or sensors that detect input into the mobile object 100 such as a rotary encoder or the like.

Information that the state detection sensor 102 acquires is used for predicting a track of the mobile object 100 by the information indicating device 103.

The information indicating device 103

controls information on the environment detection sensor 101 and the state detection sensor 102, and decides information to be sent to the tactile sensation indicating device 201, and

generates proper tactile sensation information by processing the information acquired from the environment detection sensor 101 and the state detection sensor 102, by using an internal module.

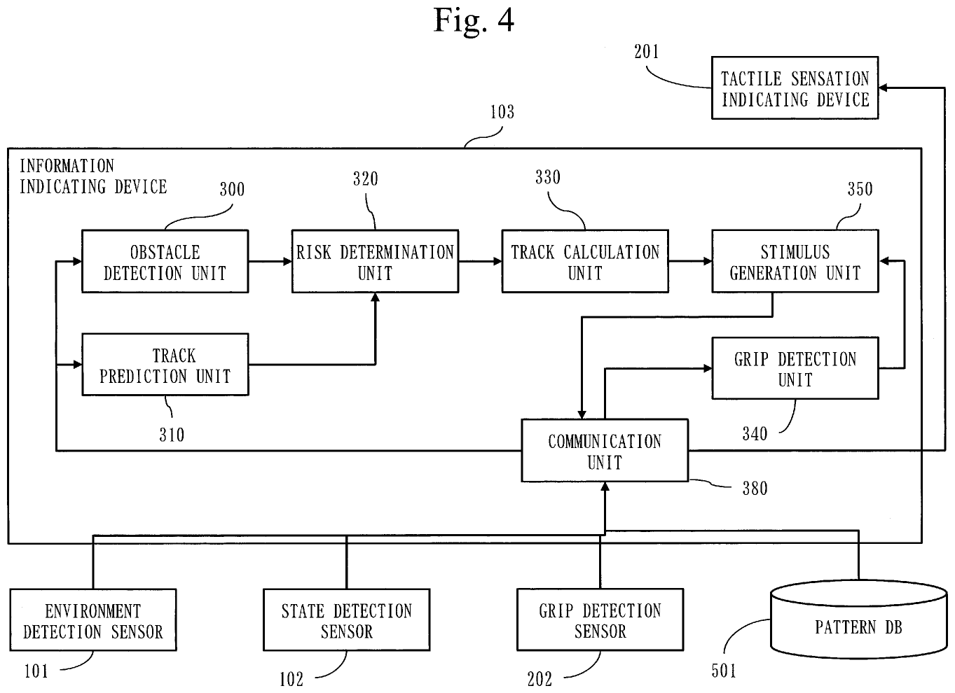

FIG. 4 is a diagram illustrating a configuration example of the information indicating device 103 according to the present embodiment.

As illustrated in the present drawing, the information indicating device 103 is constituted of an obstacle detection unit 300, a track prediction unit 310, a risk determination unit 320, a track calculation unit 330, a grip detection unit 340, a stimulus generation unit 350, a communication unit (interface) 380, and a recording unit 390. Note that, the recording unit 390 is not illustrated in the present drawing.

The obstacle detection unit 300

detects an obstacle in the surroundings of the mobile object 100 based on data from the environment detection sensor 101, and

typically calculates obstacle information constituted of: distance to the detected obstacle; an angle formed by a traveling direction of the mobile object 100 and the obstacle; and a size of the obstacle. The obstacle detection unit 300 may include in the obstacle information, another information regarding the obstacle such as a shape of the obstacle.

The obstacle detection unit 300 calculates the obstacle information for each obstacle when a plurality of obstacles are detected.

The track prediction unit 310 calculates a prediction track of the mobile object 100 based on the mobile object information acquired from the state detection sensor 102.

The risk determination unit 320

typically determines whether or not there is a possibility that the mobile object 100 contacts with the obstacle, based on the obstacle information that the obstacle detection unit 300 has calculated and the prediction track of the mobile object 100 that the track prediction unit 310 has calculated.

The risk determination unit 320 executes the above-described process for each obstacle when there are a plurality of obstacles.

The track calculation unit 330

calculates a track on which the mobile object 100 avoids an obstacle determined by the risk determination unit 320 to possibly contact with the mobile object 100, and

calculates speed and a steering angle required to travel on the calculated track.

When there are a plurality of the high-risk obstacles, the track calculation unit 330 calculates a track and the like on which the mobile object 100 avoids all of the high-risk obstacles.

The grip detection unit 340 typically

generates grip information based on grip detection information regarding a contact state between the driver and the steering wheel 200, which is the grip detection information that the recording unit 390 records, and pattern information that a pattern DB (database) 501 stores, and

records the generated grip information in the recording unit 390.

The grip information includes information on a part of the palm and the like by which the driver grips the steering wheel 200,

is typically information that includes a grip area, a grip hand, and a grip finger, and

includes information on the grip area and the grip finger in each hand when the grip hands are both left and right hands.

The grip area is an area on the steering wheel 200, which is an area where one hand of the driver contacts with the steering wheel 200 when the driver grips the steering wheel 200.

The palm and the like are a palm, a finger, and the like, that are parts where the driver may usually contact with the steering wheel 200 when the driver grips the steering wheel 200.

The grip hand is one hand that grips the steering wheel 200.

The grip finger is at least one finger of one hand that grips the steering wheel 200.

The pattern DB 501 is a database that stores the pattern information.

The pattern information is

information indicating a contact pattern between the palm and the like and the steering wheel 200 when a human grips the steering wheel 200,

information indicating a relation between a position of a hand and output of the grip detection sensor 202 when the human grips the steering wheel 200, and

information required when the grip detection unit 340 determines the grip hand and the grip finger.

A form of the pattern information may be arbitrary.

As a specific example, the pattern information is

information including characteristics that can be acquired when the driver puts a palm and the like on the steering wheel 200, such as: a threshold of pressure or electrostatic capacity on each part of the palm and the like, each of pressure and electrostatic capacity is generated when the driver grips the steering wheel 200; a position relation of each part; size of the part; and the like,

information regarding a relation between positional relation of parts of hands and the pressure or the electrostatic capacity, in each hand that grips the steering wheel 200.

The pattern information may be information indicating a distribution of the pressure or the electrostatic capacity.

The grip detection unit 340 typically uses the pattern information as a comparison subject.

The stimulus generation unit 350 typically generates stimulus information for leading the driver to follow control information that the recording unit 390 records.

The stimulus information is information on a stimulus that the tactile sensation indicating device 201 gives to the driver, and typically includes a stimulus position and a stimulus pattern.

The stimulus position is a position on the tactile sensation indicating device 201, which is a position that the tactile sensation indicating device 201 stimulates on the palm and the like of the driver.

As a specific example, the stimulus pattern is formed by parts that the tactile sensation indicating device 201 stimulates on the palm and the like of the driver, the order and the timing regarding the parts to be stimulated, and the like.

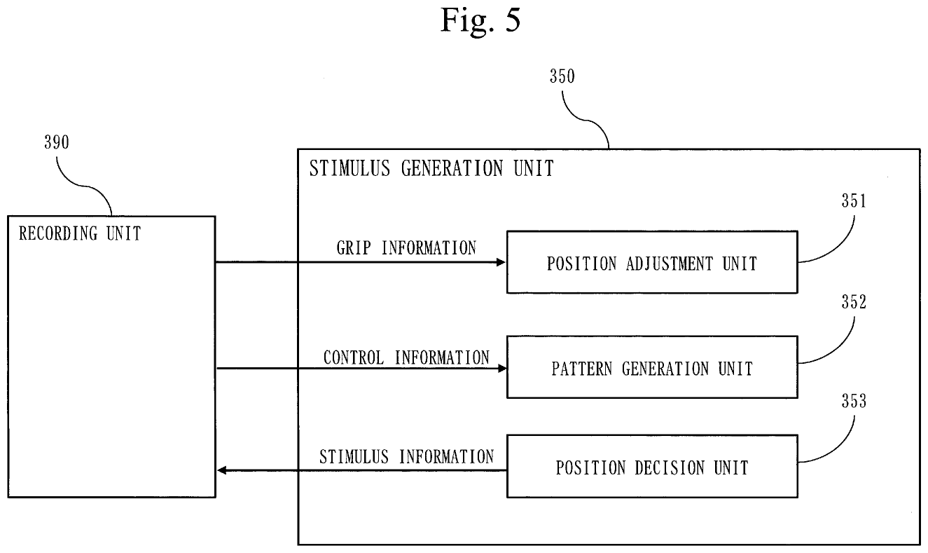

FIG. 5 is a diagram illustrating a configuration example of the stimulus generation unit 350.

As illustrated in the present drawing, the stimulus generation unit 350 is constituted of a position adjustment unit 351, a pattern generation unit 352, and a position decision unit 353.

The communication unit 380 is an interface through which the information indicating device 103 communicates with equipment which is outside. It does not matter whether a communication method of the communication unit 380 is wired or wireless.

The recording unit 390 records information required in a process of each unit of the information indicating device 103. Each unit other than the recording unit 390 of the information indicating device 103 can records information on the recording unit 390.

The grip detection sensor 202

is a sensor that detects that the driver grips the steering wheel 200, and

may be a pressure sensor, an electrostatic capacity-type sensor, or another sensor.

When the grip detection sensor 202 is a pressure sensor, the grip detection sensor 202 can detect contact intensity of the grip area since pressure is generated on a contact part between the palm and the like of the driver and the steering wheel 200 in such a manner that the driver grips the steering wheel 200.

When the grip detection sensor 202 is an electrostatic-capacity type sensor, the grip detection sensor 202 can detect the grip area since the electrostatic capacity is changed due to a difference of a gap between the palm and the like and the steering wheel 200 when the driver grips the steering wheel 200.

The grip detection sensor 202 may be something obtained by combining a plurality of types of sensors.

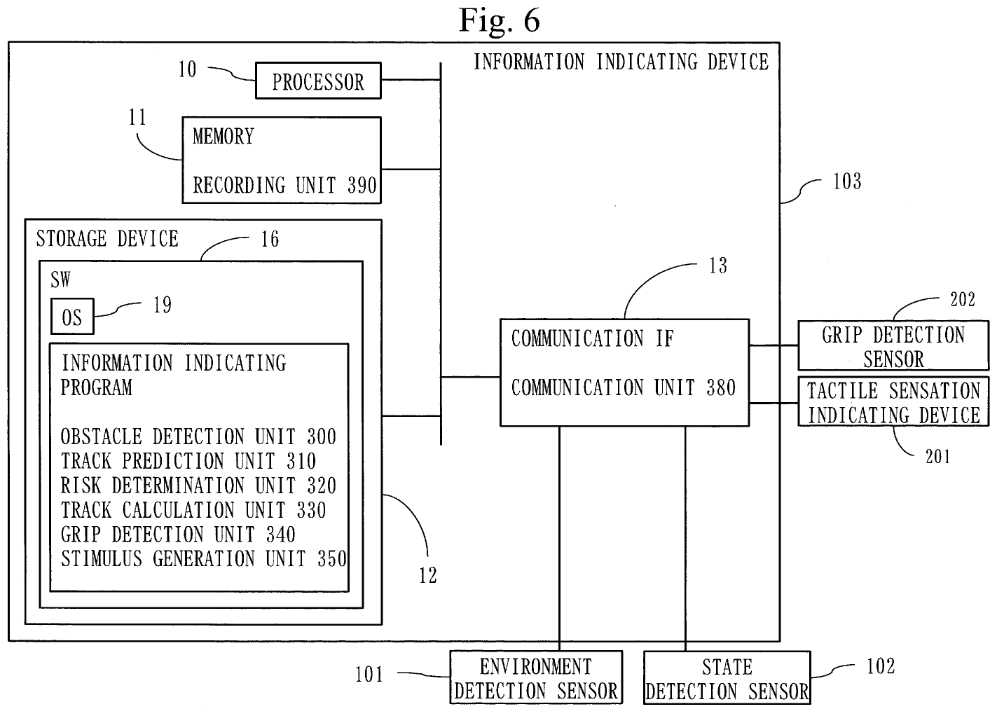

FIG. 6 is a diagram illustrating a hardware configuration example of the information indicating device 103.

As illustrated in the present drawing, the information indicating device 103 is constituted of a processor 10, a memory 11, a storage device 12, and a communication IF 13.

As a specific example, a device used as the information indicating device 103 is an ECU (Electric Control Unit).

The processor 10

is a processing device that executes an information indicating program, an OS (Operating System), and the like, and

is connected to the memory 11, performs temporary storage of data and/or save of data necessary for computation, and reads out and executes a program stored in the memory 11.

A processing device

is sometimes called an IC (Integrated Circuit), and

as a specific example, CPU (Central Processing Unit).

The information indicating device 103 may include a plurality of processors that substitute the processor 10. This plurality of processors share and execute each function of a program. As a specific example, each processor is the CPU.

The memory 11 is a storage that temporarily stores data which is in the middle of program processing, and as a specific example, a RAM (Random Access Memory), a flash memory, or a combination of these.

The recording unit 390 is constituted of the memory 11.

The storage device 12

stores the information indicating program, each program executed by the processor 10, SW 16, data used at a time of executing each program, and the like, and

as a specific example, is an HDD (Hard Disk Drive) or an SSD (Solid State Drive).

The communication IF 13

includes a receiver that receives data that the information indicating device 103 uses, and a transmitter that transmits data that the information indicating device 103 outputs,

receives data that the environment detection sensor 101 and/or the state detection sensor 102 output according to instruction from the processor 10, and transmits the data to the tactile sensation indicating device 201, and

as a specific example, is Ethernet (registered trademark) or a CAN (Controller Area Network).

The communication unit 380 is constituted of a communication IF.

Note that, the communication IF 13 may be a plurality of ports.

The SW 16 indicates a software configuration of the present embodiment, and is constituted of the obstacle detection unit 300, the track prediction unit 310, the risk determination unit 320, the track calculation unit 330, the grip detection unit 340, the stimulus generation unit 350, and an OS 19.

The OS 19 is loaded from the storage device 12 by the processor 10, expanded on the memory 11, and executed by the processor 10.

The information indicating program is read into the processor 10 from the memory 11, and executed by the processor 10.

A function of the information indicating device 103 is realized by the information indicating program.

Data and the like that the information indicating program handles are stored in the memory 11, the storage device 12, or a register or a cash memory in the processor 10.

Data that the communication IF 13 acquires and a computation result of the information indicating program are typically stored in the memory 11. The data and the like stored in the memory 11 and the storage device 12 are input and output according to a request from the processor 10.

The information indicating program may be provided by being recorded in a computer-readable medium, provided by being stored in a storage medium, and provided as a program product.

The OS 19 and the SW 16 may be stored in the memory 11.

The recording unit 390 may be constituted of the storage device 12, and constituted of the memory 11 and the storage device 12.

***Description of Operation***

An operation procedure of the information indicating device 103 is equivalent to an information indicating method. Further, a program that realizes operation of the information indicating device 103 is equivalent to the information indicating program.

The information indicating device 103 transmits to the driver, information which leads the driver to avoid the obstacle, via the tactile sensation of the driver.

In the present embodiment, typically while the mobile object 100 operates,

the environment detection sensor 101 always detects the environment information, and

the state detection sensor 102 always detects the mobile object information.

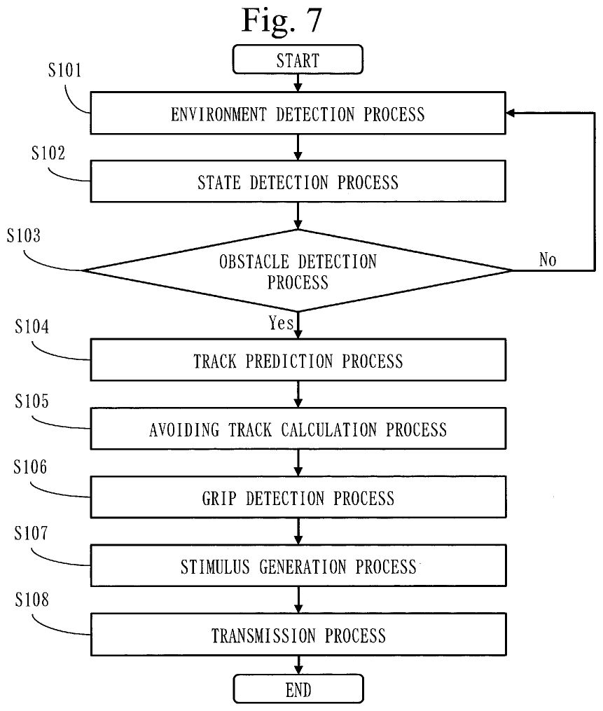

FIG. 7 is an example of a flowchart illustrating the operation of the information indicating device 103. The information indicating device 103 may change the order of processes illustrated in the present drawing, as necessary, and may execute some of the processes simultaneously.

(Step S101: Environment Detection Process)

The obstacle detection unit 300

acquires via the communication unit 380, the information on the environment around the mobile object 100 that the environment detection sensor 101 has detected, and

records the acquired information on the environment in the recording unit 390.

(Step S102: State Detection Process)

The track prediction unit 310

acquires via the communication unit 380, the mobile object information that the state detection sensor 102 has detected, and

records the acquired mobile object information in the recording unit 390.

(Step S103: Obstacle Detection Process)

The obstacle detection unit 300

detects the obstacle based on the environment information that the recording unit 390 has recorded, and

the obstacle detection unit 300, when at least one obstacle is detected, records the information on the obstacle in the recording unit 390 as the obstacle information.

A method in which the obstacle detection unit 300 detects the obstacle may be arbitrary.

As a specific example, the obstacle detection unit 300

detects an obstacle area by image-processing an image that the camera has acquired,

calculates a distance between the mobile object 100 and the detected obstacle area based on information that the LiDAR, the millimeter wave radar, and/or the like have/has acquired, and

determines whether or not there is a possibility that the mobile object 100 and the obstacle in the obstacle area contact with each other, based on the calculated distance.

The risk determination unit 320 determines whether or not there is a possibility that the mobile object 100 and the detected obstacle contact with each other, based on the obstacle information that the recording unit 390 has recorded.

The risk determination unit 320, when a plurality of obstacles are included in the obstacle information, determines whether or not there is a possibility that the mobile object 100 and each of the obstacles contact with each other.

The information indicating device 103

proceeds to step S104 when the risk determination unit 320 determines that there is a possibility that the mobile object 100 and at least one of the detected obstacles contact with each other, and

otherwise, proceeds to step S101.

(Step S104: Track Prediction Process)

The track prediction unit 310

predicts the track of the mobile object 100 based on the mobile object information that the recording unit 390 has recorded, and

stores the predicted track in the recording unit 390 as track prediction information.

As a specific example, the track prediction unit 310

calculates turning speed of the mobile object 100 based on the information that a gyro sensor has acquired,

calculates traveling speed of the mobile object 100 based on the information that an acceleration sensor and/or a wheel speed sensor have/has acquired, and

predicts the track of the mobile object 100 based on the turning speed and the traveling speed.

(Step S105: Avoiding Track Calculation Process)

The track calculation unit 330

calculates an avoiding track where the obstacle can be avoided, based on the obstacle information and the track prediction information that the recording unit 390 has recorded,

calculates control information required to travel on the avoiding track, and

stores the calculated avoiding track and the control information in the recording unit 390.

As a specific example, the control information is information on the steering angle required to travel on the avoiding track.

(Step S106: Grip Detection Process)

The grip detection unit 340

acquires the grip detection information from the grip detection sensor 202,

stores the acquired grip detection information in the recording unit 390,

generates the grip information based on the acquired grip detection information and the pattern information that the pattern DB 501 has stored, and

records the generated grip information in the recording unit 390.

(Step S107: Stimulus Generation Process)

The stimulus generation unit 350

generates the stimulus information based on the grip information and control information that the recording unit 390 has recorded, and

records the generated stimulus information in the recording unit 390.

As a specific example, the stimulus generation unit 350 generates the stimulus information which leads the driver to turn the steering in a direction that the control information indicates.

(Step S108: Transmission Process)

The stimulus generation unit 350 transmits to the tactile sensation indicating device 201 via the communication unit 380, the stimulus information that the recording unit 390 has recorded.

The tactile sensation indicating device 201 indicates the information to the driver by stimulating the palm and the like of the driver based on the received stimulus information.

***Description of Operation of Grip Detection Process***

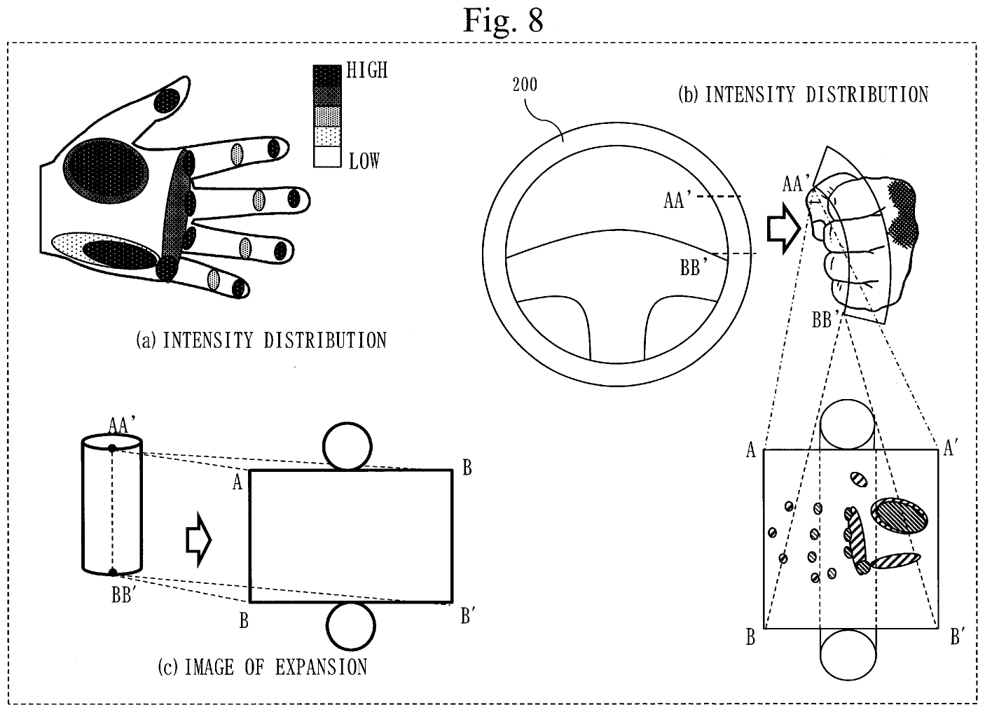

FIG. 8 is a diagram explaining an example of the pattern information.

A diagram illustrated at the upper left of the present drawing is a diagram illustrating an example of a distribution of pressure and an example of a distribution of the electrostatic capacity when a human grips a bar-shaped object.

When the human grips the bar-shaped object, usually, the pressure and the electrostatic capacity between the palm and the like and the bar-shaped object are high at a thenar eminence of a base of a first finger, a hypothenar eminence of a base of a fifth finger, and each finger tip of the first to the fifth fingers.

A diagram illustrated in a right side of the present drawing is a diagram illustrating an example of a pressure distribution of grip area surroundings when the driver grips the steering wheel 200. A diagram illustrated at a lower right is a diagram in which a surface part of the grip area surroundings is expanded as indicated in an image of the expansion, and is a diagram illustrating an example of the pressure distribution of the grip area surroundings.

As a specific example, the pattern DB 501 records as the pattern information, information in which the pressure distribution and parts of the hand illustrated in the present drawing are linked.

As a specific example, the grip detection unit 340 determines the grip hand and the grip finger by comparing such pattern information with the grip detection information.

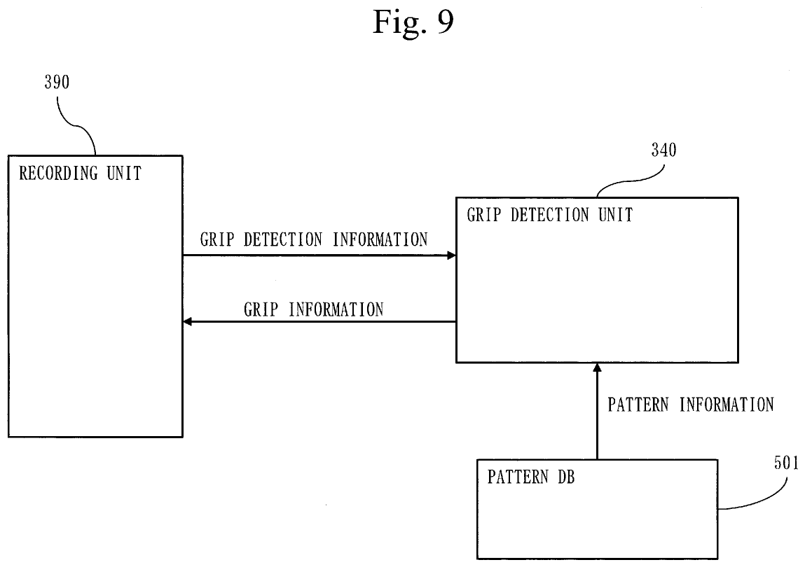

FIG. 9 is a diagram illustrating input/output data of the grip detection unit 340 in a grip detection process.

As illustrated in the present drawing, in the grip detection process, the grip detection unit 340

receives the grip detection information and the pattern information, and

outputs the grip information to the recording unit 390.

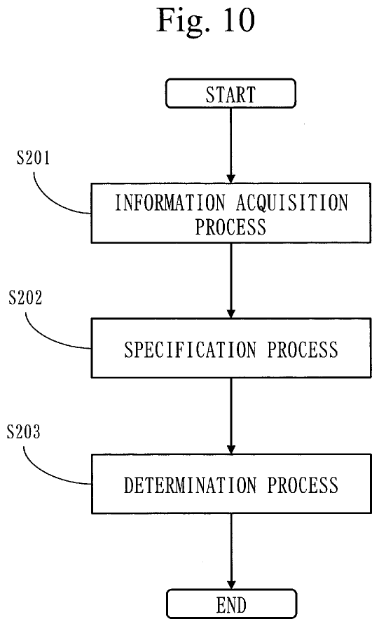

FIG. 10 is an example of a flowchart illustrating operation in the grip detection process of the grip detection unit 340. The grip detection unit 340 may change the order of processes illustrated in the present drawing as necessary.

(Step S201: Information Acquisition Process)

The grip detection unit 340

records the acquired grip detection information in the recording unit 390 and proceeds to step S202 when the grip detection unit 340 acquires the grip detection information from the grip detection sensor 202, and

continues the process of the present step in cases other than this.

(Step S202: Specific Process)

The grip detection unit 340

specifies a grip area based on the grip detection information that the recording unit 390 has recorded, and

records the specified grip area in the recording unit 390.

The grip detection unit 340 specifies each grip area when there are a plurality of grip areas.

(Step S203: Determination Process)

The grip detection unit 340

reads out the pattern information from the pattern DB 501,

determines the grip hand and the grip finger for each grip area by comparing with the pattern information, the grip detection information that the recording unit 390 has recorded, and

records in the recording unit 390, the determined grip hand and grip finger in association with the grip area.

The grip detection unit 340 may adopt an arbitrary method as a means of determining the grip hand and the grip finger, and as a specific example, the grip detection unit 340 adopts template matching or a means which is based on machine learning.

As a specific example, the grip detection unit 340 determines the grip hand and the grip finger by having as reference, parts with which the driver certainly contacts when the driver grips the object, such as the thenar eminence, the first finger, and the like, and comparing distances from those parts, a position relation, a threshold of intensity of output, and/or the like with the pattern information.

***Description of Operation of Stimulus Generation Process***

A stimulus generation process illustrated in step S107 will be descried.

As a specific example, the stimulus generation unit 350 generates the stimulus information corresponding to a stimulus which causes a phenomenon called apparent motion. A stimulus of the stimulus information in the present example is something that gives illusion to the driver as if the grip area moved, by sequentially changing the stimulus position at a certain interval. In the present example, the tactile sensation indicating device 201 leads the driver to turn to the left or turn to the right, the steering wheel 200 based on the stimulus information.

Below, the stimulus information in the present example will be described specifically.

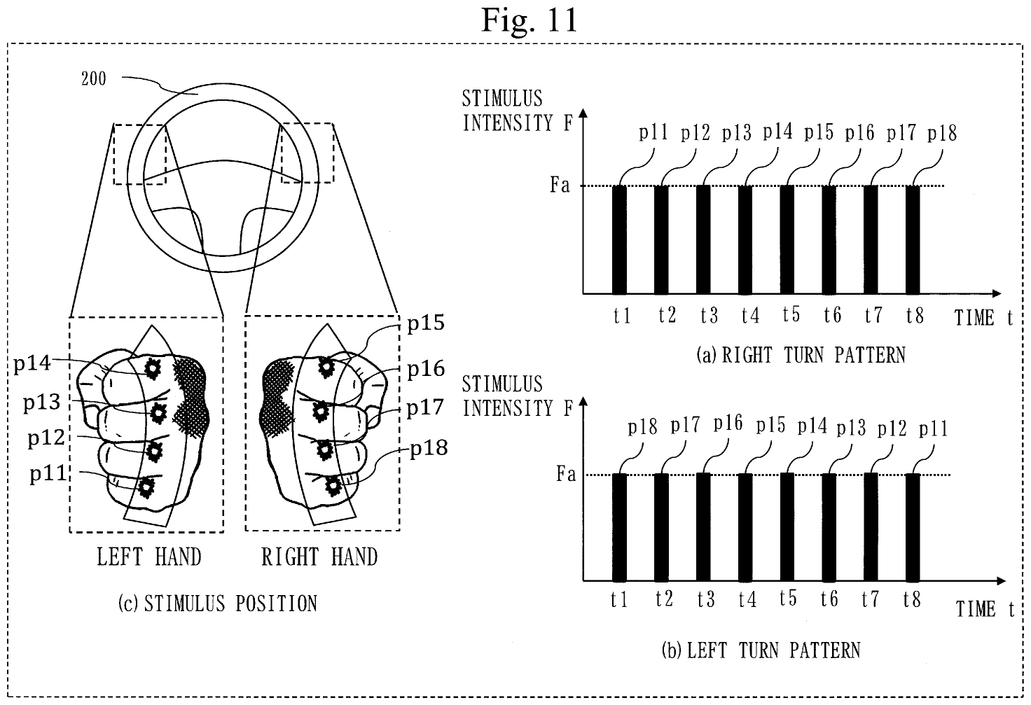

FIG. 11 is a diagram illustrating an example of the stimulus information.

In the present drawing,

p11 to p18 represent stimulus positions of the stimulus information,

the right turn pattern is a diagram representing a relation between time, stimulus intensity, and the stimulus position in a case of leading the driver to turn the steering wheel 200 to the right, and

the left turn pattern is the same as the right turn pattern except for reading the right turn in the right turn pattern as the left turn.

The stimulus intensity is intensity of the stimulus.

When the stimulus generation unit 350 leads the driver to turn to the right, the steering wheel 200, the stimulus generation unit 350 generates stimulus information illustrated in the right pattern, that is to generate the stimulus information corresponding to a stimulus given to the palm and the like by changing the stimulus position every certain time in order.

When the tactile sensation indicating device 201 stimulates the palm and the like based on the stimulus information illustrated in the right turn pattern, the tactile sensation indicating device 201 generates apparent motion of a right turn by giving the stimulus in order such as giving a stimulus which is stimulus intensity Fa to p11 at a time t1 and giving a stimulus which is stimulus intensity Fa to p12 at a time t2.

When the stimulus generation unit 350 leads the driver to turn the steering wheel 200 to the left, the stimulus generation unit 350 generates the stimulus information illustrated in the left turn pattern.

Note that, when the driver grips the steering wheel 200 by only a left hand or a right hand, the stimulus generation unit 350 generates the stimulus information, which stimulates only a hand gripping the steering wheel 200, in the same manner as the stimulus information that stimulates both hands.

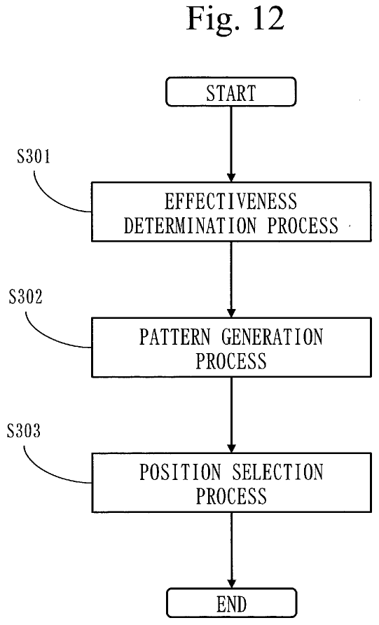

FIG. 12 is an example of a flowchart illustrating operation of the stimulus generation unit 350. The stimulus generation unit 350 may change the order of processes illustrated in the present drawing as necessary.

The stimulus generation unit 350 executes the processes of the present flowchart in the same way regardless of whether the driver grips the steering wheel 200 by both hands or by one hand.

(Step S301: Effectiveness Determination Process)

The position adjustment unit 351 generates effective part information based on the grip information that the recording unit 390 has recorded.

The effective part information includes information on a part of the driver to which the tactile sensation indicating device 201 can give an effective stimulus, which is a part of the palm and the like of the driver.

(Step S302: Pattern Generation Process)

The pattern generation unit 352 generates a stimulus pattern typically including the stimulus intensity and an output frequency, based on the control information that the recording unit 390 has recorded.

(Step S303: Position Selection Process)

The position decision unit 353

selects a stimulus position that causes apparent motion based on the effective part information that the position adjustment unit 351 has generated and the stimulus pattern that the pattern generation unit 352 has generated,

generates the stimulus information based on the stimulus position and the stimulus pattern, and

records the generated stimulus information in the recording unit 390.

When the driver grips the steering wheel 200 by using both hands and the driver grips the steering wheel 200 by using five fingers of both hands, as a specific example, when the driver is led to turn the steering wheel 200 to the left, the position decision unit 353 selects the stimulus positions corresponding to p11 to p18 of FIG. 11.

### Characteristics of First Embodiment

The information indicating device 103,

that is the information indicating device 103 transmitting the stimulus information to the steering wheel 200 of the mobile object 100 including the steering wheel 200 that indicates the information to the driver based on the stimulus information corresponding to the stimulus, includes:

the grip detection unit 340 to receive from the steering wheel 200, the grip detection information regarding a contact state between the driver and the steering wheel 200, receive the pattern information from the pattern database 501 that stores the pattern information indicating the contact pattern between the steering wheel 200 and the palm and the like when the human grips the steering wheel 200, determine a part of the palm and the like by which the driver grips the steering wheel 200, based on the grip detection information and the pattern information, and generate the grip information including the information on the part of the palm and the like; and

the stimulus generation unit 350 to, when there is a possibility that the mobile object 100 contacts with the obstacle that is located around the mobile object 100, generate based on the grip information, the stimulus information that leads the driver to avoid the obstacle by stimulating the palm and the like.

The information indicating device 103 includes:

the obstacle detection unit 300 to receive from the mobile object 100, the environment information indicating the environment in the surroundings of the mobile object 100; and

the risk determination unit 320 to, based on the environment information, detect the obstacle and determine whether or not there is a possibility that the mobile object 100 and the obstacle contact with each other.

The information indicating device 103 includes:

the track prediction unit 310 to receive from the mobile object 100, the mobile object information including speed, acceleration, turning speed, and a steering angle of the mobile object 100, and generate the track prediction information by predicting the track of the mobile object 100 based on the mobile object information; and

the track calculation unit 330 to generate the control information based on the track prediction information, and

the stimulus generation unit 350 generates the stimulus information based on the grip information and the control information.

The stimulus generation unit 350 generates the stimulus information corresponding to the stimulus that generates the apparent motion.

The stimulus generation unit 350 leads the driver to turn the steering wheel 200 to the right by setting the stimulus corresponding to the stimulus information to the stimulus that stimulates the left hand and the right hand of the driver alternately, which is a stimulus that stimulates bases of a fifth finger to a second finger of the left hand of the driver one by one in order, which is a stimulus that stimulates bases of a second finger to a fifth finger of the right hand of the driver one by one in order, which is a stimulus that changes at a certain interval, a part to stimulate.

### Description of Effect of First Embodiment

As described above, according to the present embodiment,

the grip detection unit 340 generates the grip information based on the grip detection information received from the grip detection sensor 202 that the steering wheel 200 includes, and the pattern information received from the pattern DB 501, and

in such a manner that the stimulus generation unit 350 generates the stimulus information based on the grip information,

the stimulus generation unit 350 can generate the stimulus information, which transmits the information to the driver properly regardless of the area which the driver grips on the steering wheel 200 and the hand by which the driver grips the steering wheel 200, which is stimulus information that the tactile indicating device installed in the steering wheel 200 can use.

According to the present embodiment, when the pattern information is acquired from the pattern DB 501 that stores the pattern information regarding intensity distributions of: the grip hand; the grip fingers; the pressure distribution; and the like as illustrated in FIG. 8, it is possible to compare the pattern information with the intensity distribution detected based on the grip detection information, determine the grip hand and the grip finger, and generate the stimulus information that gives the stimulus to the driver according to the position of the grip hand and/or the grip finger.

Therefore, according to the present embodiment, even when the driver is replaced or when the driver changes how to hold the steering wheel 200, it is possible to generate the stimulus information that leads the driver by giving the stimulus to the proper position.

Therefore, according to the present embodiment, it is possible to support the driver to drive the mobile object 100 more safely.

Further, according to the present embodiment, the grip detection unit 340 can determine not only the grip hand but also the parts of the palm and five fingers that grip the steering wheel 200. Therefore, the stimulus generation unit 350 can properly select the stimulus position within a range of the grip area regardless of a grip method.

As a specific example, even when the driver of the mobile object 100 grips the left side of the steering wheel 200 by the right hand and the right side by the left hand at a time of turning, it is possible to generate the stimulus information that indicates the proper stimulus to the right and left hands. The left side of the steering wheel 200 means the left side of the steering wheel 200 as the driver views the steering wheel 200 in a state where the steering wheel 200 is not turned.

According to the present embodiment, since it is possible to detect the grip state of the driver regardless of the grip method, it is possible to generate the stimulus information that gives the stimulus according to the grip method even when the driver crosses the hands at a time of turning or when a person who has disability such as finger loss or the like drives the mobile object 100.

Further, even when the mobile object 100 of the driver deviates from a lane by not looking the forward or the like during the drive and there is a possibility that the mobile object 100 and the obstacle contact with each other or when there is a possibility that the mobile object 100 contacts with the obstacle that has approached the mobile object 100 in the driver's blind spot at a time of changing the lane,

the stimulus generation unit 350 generates the stimulus information corresponding to the stimulus that leads the driver to steer in a direction that the control information indicates, and

the tactile sensation indicating device 201 can lead the driver to avoid the obstacle by indicating information to the driver based on the stimulus information.

Below, an effect according to the present embodiment will be described with the drawing.

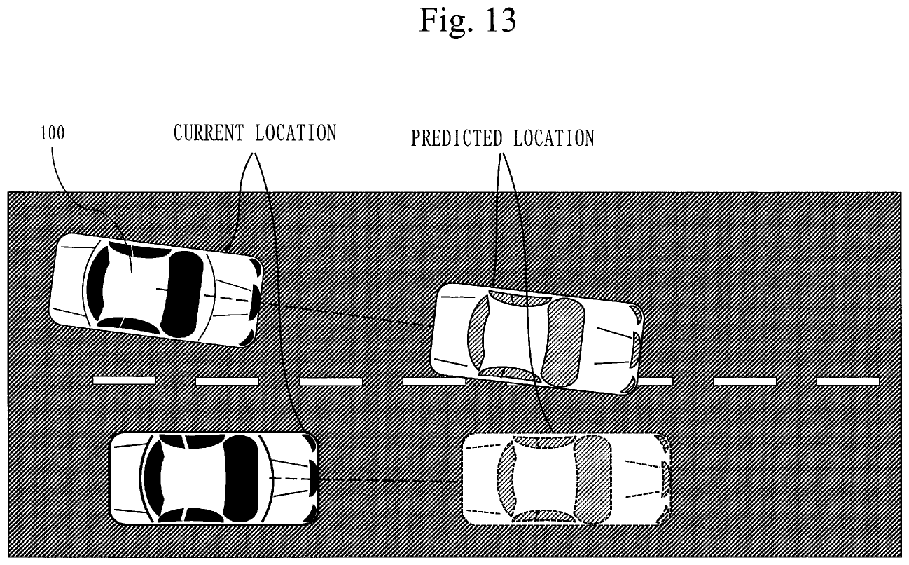

FIG. 13 is a diagram representing an image when the mobile object 100 deviates from the lane and the mobile object 100 is expected to contact with another car.

When the mobile object 100 predicts that the mobile object 100 deviates from the lane and there is a possibility of contacting with another car as shown in the present drawing,

the stimulus generation unit 350 generates the stimulus information illustrated in the left turn pattern in FIG. 11, and

the tactile sensation indicating device 201 leads the driver to turn the steering wheel 200 to the left by stimulating the palm and the like of the driver based on the stimulus information as illustrated in the left turn pattern and generating the apparent motion.

Therefore, according to the present embodiment, when the mobile object 100 deviates from the lane and there is a possibility of contacting with another car, it is possible to generate the stimulus information that leads the driver to drive the mobile object 100 not to deviate from the lane.

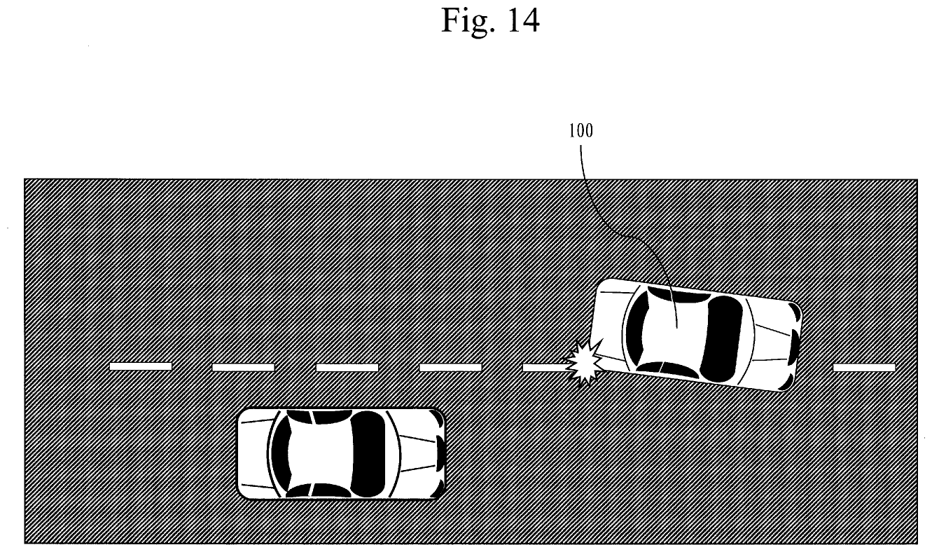

FIG. 14 is a diagram that represents an image when the mobile object 100 moves to another lane and the mobile object 100 is expected to contact with another car.

When the risk determination unit 320 predicts that the mobile object 100 deviates from the lane and there is a possibility of contacting with another car as shown in the present drawing,

the stimulus generation unit 350 generates the stimulus information as illustrated in the left turn pattern in FIG. 11, and

the tactile sensation indicating device 201 leads the driver to prevent the mobile object 100 from moving to another lane by stimulating the palm and the like of the driver based on the stimulus information as illustrated in the left turn pattern and generating the apparent motion.

Therefore, according to the present embodiment, when the mobile object 100 moves to another lane or the like and there is a possibility of contacting with another car, it is possible to generate the stimulus information that leads the driver to stay in the same lane.

### First Modification Example

The information indicating device 103 does not need to be installed in the mobile object 100.

In the present modification example, the information indicating device 103 communicates with the mobile object 100 via the communication unit 380.

### Second Modification Example

The information indicating device 103 does not need to acquire the environment information from the environment detection sensor 101 that the mobile object 100 includes.

In the present modification example, the information indicating device 103 may acquire the environment information from another car by using inter-vehicle communications, may acquire the environment information from the communication device installed on a roadside by using road-to-vehicle communication, or may acquire the environment information from the central control device or the like by using a general communication network.

In the same way, the information indicating device 103

does not need to acquire the mobile object information from the state detection sensor 102 that the mobile object 100 includes, and

does not need to acquire the pattern information from the pattern DB 501 that the mobile object 100 includes.

### Third Modification Example

The information indicating device 103 does not need to include the obstacle detection unit 300.

In the present modification example, the information indicating device 103 acquires the obstacle information via the communication unit 380.

### Fourth Modification Example

The information indicating device 103 does not need to include the track prediction unit 310.

In the present modification example, the information indicating device 103 acquires the track prediction information via the communication unit 380.

### Fifth Modification Example

The information indicating device 103 does not need to include the risk determination unit 320.

In the present modification example, the information indicating device 103

acquires via the communication unit 380, information regarding whether or not there is a possibility of contacting with the obstacle, and

may transmit to the outside via the communication unit 380, information required to generate the information regarding whether or not there is a possibility of contacting with the obstacle.

### Sixth Modification Example

The information indicating device 103 does not need to include the track calculation unit 330.

In the present modification example, the information indicating device 103

acquires the control information via the communication unit 380, and

transmits to the outside via the communication unit 380, information required to generate the control information.

### Seventh Modification Example

The information indicating device 103 may be constituted of a plurality of computers.

### Eighth Modification Example

The risk determination unit 320 may consider the track prediction information when the risk determination unit 320 determines whether or not there is a possibility of contacting with the obstacle.

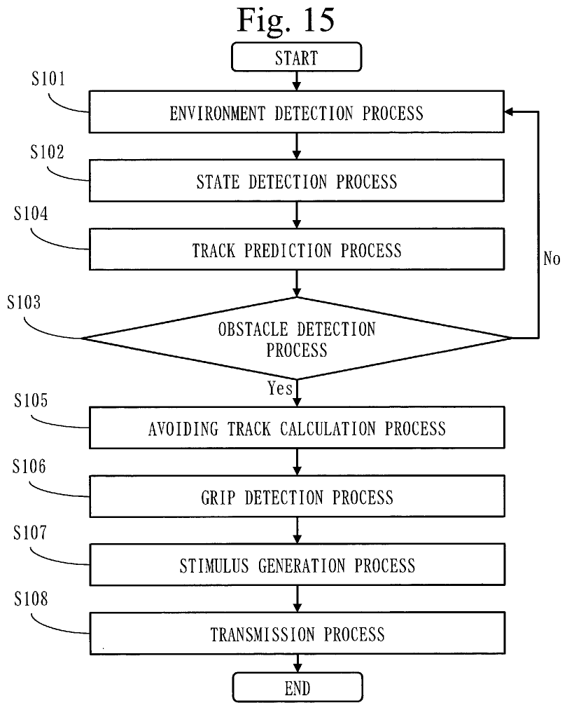

FIG. 15 is an example of a flowchart illustrating operation of the information indicating device 103 in the present modification example.

In the present modification example,

the information indicating device 103 executes the process of step S104 before the process of step S103 is executed, and

in step S103, the risk determination unit 320 determines whether or not there is a possibility of contacting with the obstacle, based on the obstacle information and the track prediction information which are recorded by the recording unit 390.

### Ninth Modification Example

When the detected obstacle moves, the risk determination unit 320 predicts a track of the obstacle, and determines whether or not the mobile object 100 contacts with the obstacle, by considering the predicted track.

### Tenth Modification Example

The grip detection unit 340 does not need to detect the grip area.

In the present modification example, the grip detection unit 340 typically acquires and uses information on the grip area that the grip detection sensor 202 has detected.

### Eleventh Modification Example

The grip detection unit 340 does not need to determine the grip finger.

In the present modification example, the stimulus generation unit 350 typically generates the stimulus information that stimulates a part other than the grip finger on the grip area.

### Twelfth Modification Example

The stimulus generation unit 350 may transmit to the driver, an amount of how much the driver turns the steering wheel 200, by setting a time interval to stimulate.

In the present modification example, the stimulus generation unit 350 typically

generates stimulus information which has a short time interval to stimulate at a time of leading the driver to turn the steering wheel 200 a lot, and

generates stimulus information which has a long time interval to stimulate at a time of leading the driver to turn the steering wheel 200 a little.

### Thirteenth Modification Example

A position relation between the tactile sensation indicating device 201 and the grip detection sensor 202 may be arbitrary.

### Fourteenth Modification Example

The tactile sensation indicating device 201 and the grip detection sensor 202 may not be placed all around the steering wheel 200, and may be placed on only a general area that a driver grips.

### Fifteenth Modification Example

In the present embodiment, a case where each functional configuration element is realized by software has been described. However, as a modification example, each functional configuration element may be realized by hardware.

When each functional configuration element is realized by the hardware, the information indicating device 103 includes an electronic circuit 17 instead of the processor 10. Otherwise, but not illustrated, the information indicating device 103 includes the electronic circuit 17 instead of the processor 10, the memory 11, and/or the storage device 12. The electronic circuit 17 is a dedicated electronic circuit that realizes a function of each functional configuration element (and the memory 11 and the storage device 12). The electronic circuit is sometimes called a processing circuit.

The electronic circuit 17 is assumed to be a single circuit, a composite circuit, a programmed processor, a parallel-programmed processor, a logic IC, a GA (Gate Array), an ASIC (Application Specific Integrated Circuit), and an FPGA (Field-Programmable Gate Array).

Each functional configuration element may be realized by one electronic circuit 17, and each functional configuration element may be distributed over a plurality of electronic circuits 17 and realized.

Otherwise, a part of each functional configuration element may be realized by the hardware, and each of the other functional configuration elements may be realized by the software.

The above-described processor 10, the memory 11, the storage device 12, and the electronic circuit 17 are collectively referred to as “processing circuitry”. That is, a function of each functional configuration element is realized by the processing circuitry.

### Second Embodiment

Below, matters different from the above-described embodiment will be described with reference to the drawings.

***Description of Configuration***

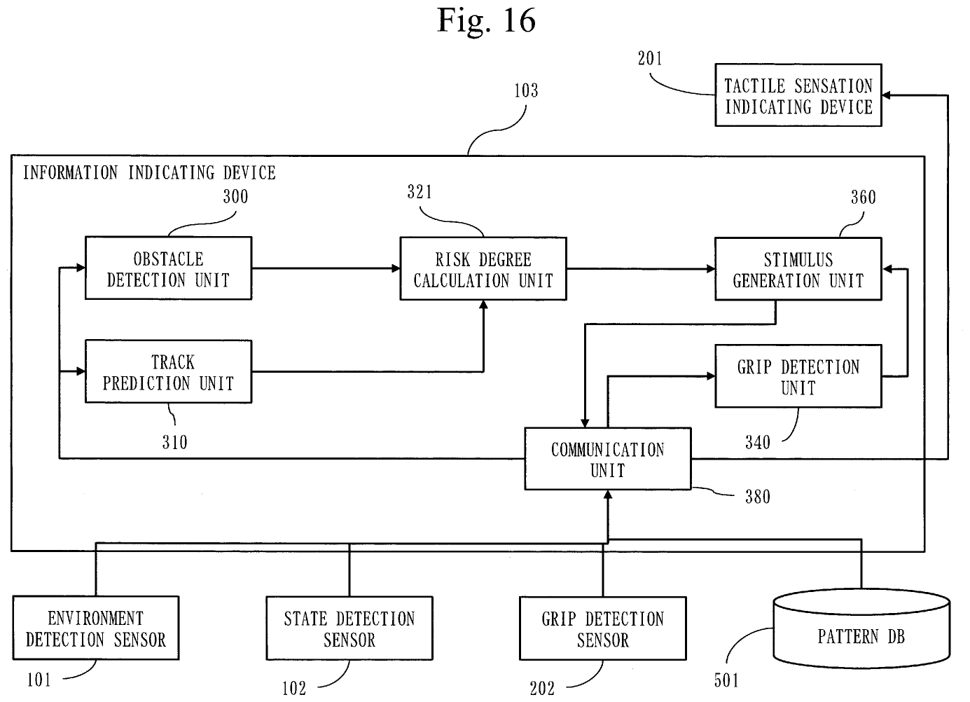

FIG. 16 is a diagram illustrating a configuration example of the information indicating device 103 according to the present embodiment.

As illustrated in the present drawing, the information indicating device 103

does not include the risk determination unit 320, the track calculation unit 330, and the stimulus generation unit 350, and

includes a risk degree calculation unit 321 and a stimulus generation unit 360.

The obstacle detection unit 300, the track prediction unit 310, and the grip detection unit 340 are the same as those in the first embodiment.

The risk degree calculation unit 321

typically calculates a risk degree of the obstacle included in the obstacle information based on the obstacle information that the obstacle detection unit 300 has calculated and the prediction track of the mobile object 100 that the track prediction unit 310 has calculated.

The risk degree calculation unit 321 calculates the risk degree for each obstacle when a plurality of obstacles are included in the obstacle information.

The stimulus generation unit 360 generates the stimulus information based on the obstacle information, the grip information, and risk degree information which are recorded by the recording unit 390.

When there are a plurality of high-risk obstacles, the stimulus generation unit 360 typically generates the stimulus information corresponding to all the high-risk obstacles.

***Description of Operation***

The information indicating device 103 according to the present embodiment

functions as a warning device that warns to the driver,

warns to the driver through the tactile sensation of the palm and the like of the driver when an obstacle exists around the mobile object 100, and

does not lead the driver to operate the steering wheel 200 by stimulus.

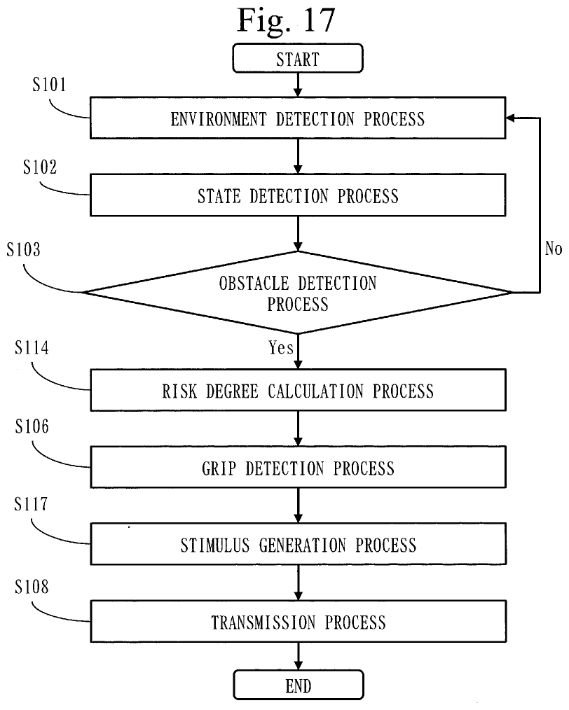

FIG. 17 is an example of a flowchart illustrating operation of the information indicating device 103. The information indicating device 103 may change the order of processes illustrated in the present drawing, as necessary.

The information indicating device 103,

instead of executing the processes of step S104 and step S105, executes a process of step S114, and

instead of executing the process of step S107, executes a process of step S117.

(Step S114: Risk Degree Calculation Process)

The risk degree calculation unit 321

calculates the risk degree of the obstacle included in the obstacle information that the recording unit 390 has recorded, based on a distance between the obstacle and the mobile object 100, speed of the mobile object 100 and/or the like,

generates the risk degree information based on the calculated risk degree, and

records the generated risk degree information in the recording unit 390.

The risk degree calculation unit 321 may calculate the risk degree of the obstacle in an arbitrary method.

(Step S117: Stimulus Generation Process)

The stimulus generation unit 360

generates the stimulus information based on the obstacle information, the grip information, and the risk degree information which are recorded by the recording unit 390, and

records the generated stimulus information in the recording unit 390.

(Step S303: Position Selection Process)

The stimulus generation unit 360 selects the stimulus position that can tell the driver a location of the obstacle, instead of selecting stimulus positions that generates the apparent motion.

An example of the stimulus information that the stimulus generation unit 360 generates will be described with reference to the drawing.

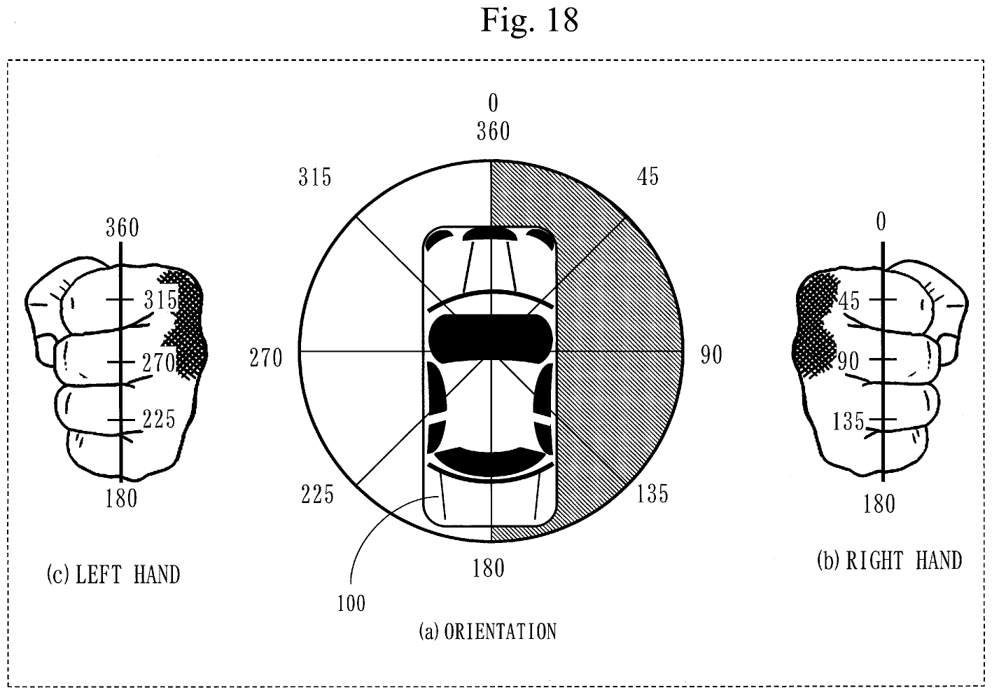

FIG. 18 is a diagram explaining the stimulus information that associates the grip area and an orientation with each other.

In the present drawing,

the driver uses both hands and grips the steering wheel 200 by using five fingers of both hands, and

bases of second fingers to fifth fingers of the both hands of the driver and the steering wheel 200 are assumed to cohere.

As a specific example, as illustrated in the present drawing, the information indicating device 103 associates the grip area and the orientation with each other.

As illustrated in the present drawing, the information indicating device 103

represents the orientation around the mobile object 100 by an angle,

assumes that a forward direction of the mobile object 100 is 0 degree,

uses an angle of a clockwise direction as the mobile object 100 is viewed from directly above, which is an angle formed by the forward direction and each direction of the mobile object 100 as the orientation,

associates the right hand of the driver with the orientation of the right side relative to the forward direction of the vehicle, and

associates the left hand of the driver with the orientation of the left side relative to the forward direction of the vehicle.

As a specific example, the stimulus generation unit 360

associates surroundings of the second finger of the right hand with 0 degree,

associates an area of the second finger to a fourth finger of the right hand with 45 degrees to 135 degrees, and

associates surroundings of a fifth finger with 180 degrees.

In the present example,

the stimulus generation unit 360 generates the stimulus information that stimulates a place corresponding to an orientation in which the obstacle is located, and

the tactile sensation indicating device 201 can intuitively transmit to the driver, the orientation in which the obstacle is located, by stimulating the palm and the like of the driver based on the stimulus information.

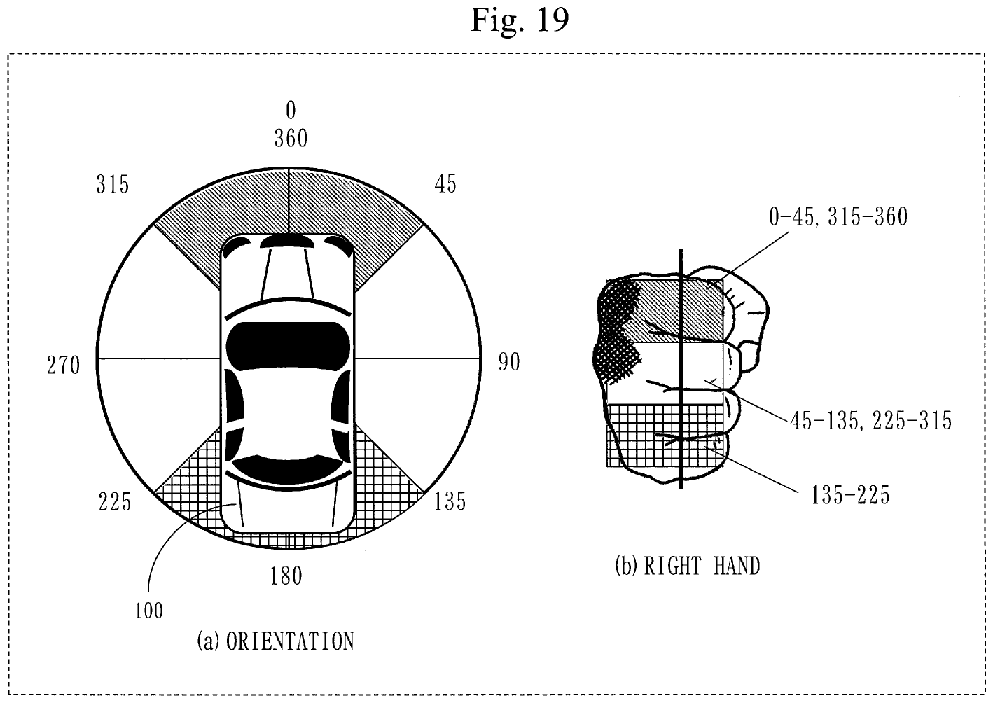

FIG. 19 is the diagram similar to FIG. 18, and is a diagram explaining the stimulus information when the driver grips the steering wheel 200 by only the right hand.

Matters different from a case where the stimulus generation unit 360 generates the stimulus information that stimulates both hands of the driver will be described below.

When the driver grips the steering wheel 200 by only the right hand, as a specific example, the stimulus generation unit 360

associates surroundings of a second finger of the right hand with 0 degree to 45 degrees and 315 degrees to 360 degrees,

associates an area of the second finger to a fourth finger of the right hand with 45 degrees to 135 degrees and 225 degrees to 315 degrees, and

associates surroundings of a fifth finger with 135 degrees to 225 degrees.

When the driver grips the steering wheel 200 by only the left hand, the stimulus generation unit 360 generates the stimulus information in the same way as the present example.

The stimulus generation unit 360 may tell the driver a distance between the mobile object 100 and the obstacle and/or the risk degree of the obstacle, by the stimulus intensity.

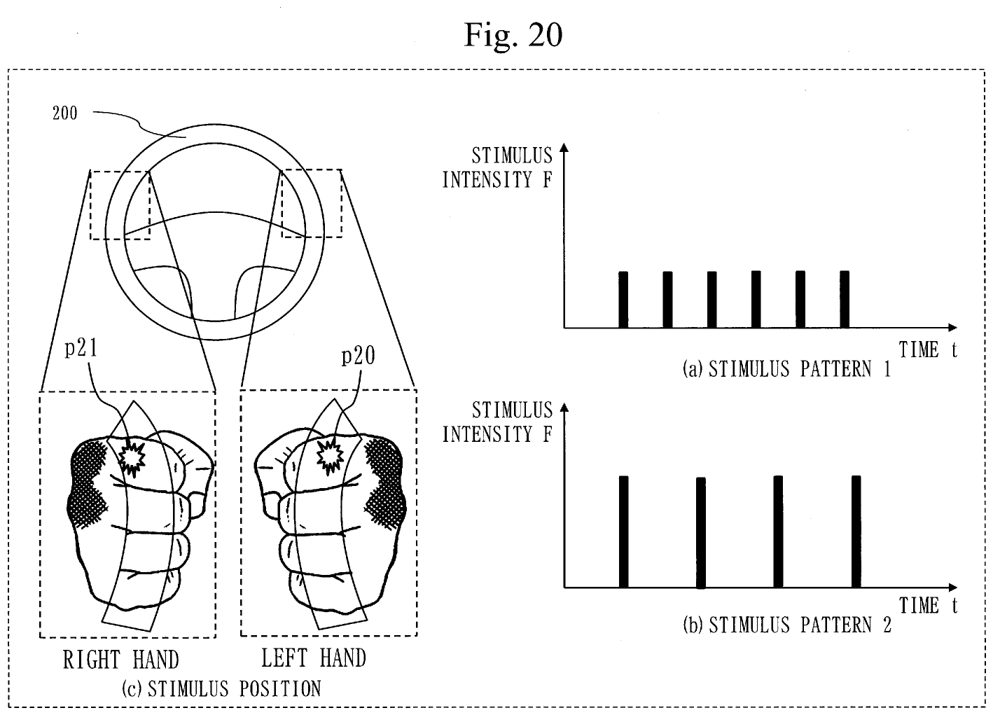

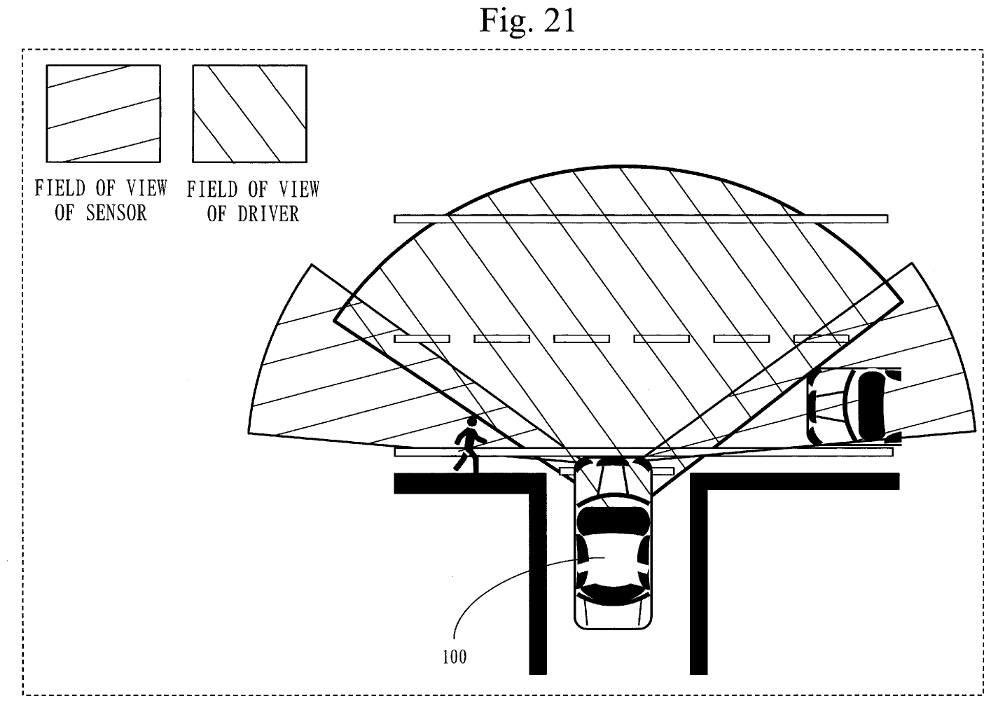

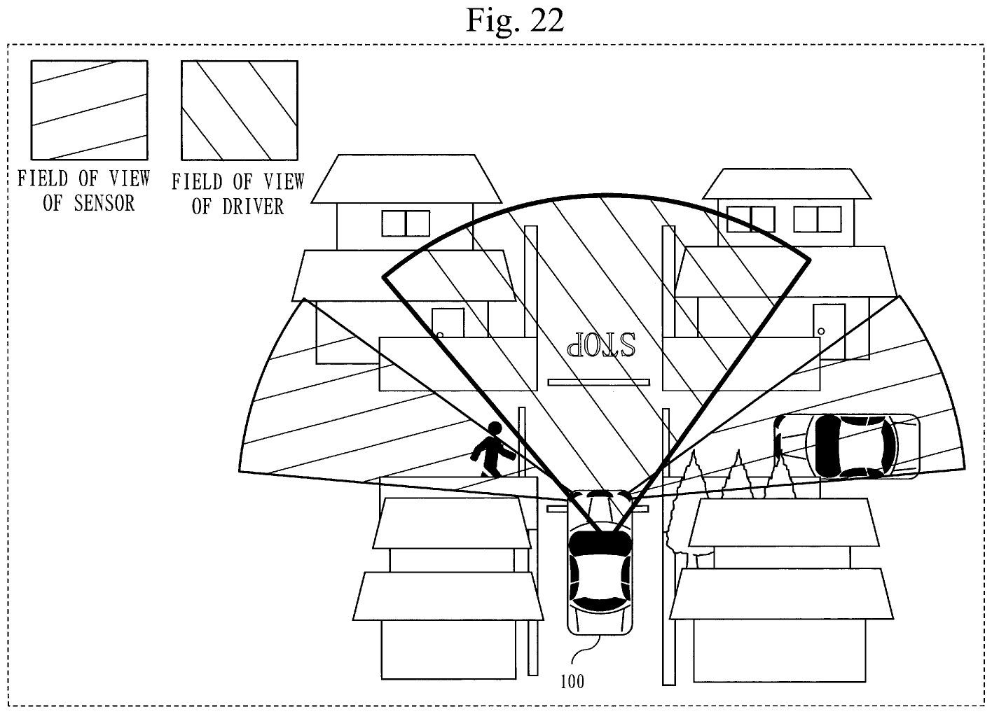

FIG. 20 is a diagram illustrating an example of the stimulus information that the stimulus generation unit 360 generates in a situation illustrated in FIGS. 21 and 22, and is a diagram illustrating a relation between the time and the stimulus intensity.

FIGS. 21 and 22 are diagrams illustrating an image where the obstacle located in a blind spot of the driver approaches the mobile object 100. A field of view of a sensor indicates a range where the environment detection sensor 101 has detected. A field of view of the driver indicates a field of view of the driver of the mobile object 100.

In the present example, the stimulus generation unit 360

stimulates p20 as illustrated in a stimulus pattern 1 in order to notify that a pedestrian exists in a left direction, and

stimulates p21 as illustrated in a stimulus pattern 2 in order to notify that a vehicle exists in a right direction.

In the present example,

since the pedestrian is closer to the mobile object 100 than the vehicle, a cycle of the stimulus of the stimulus pattern 1 is shorter than a cycle of the stimulus of the stimulus pattern 2, and

since the vehicle has a higher risk degree than the pedestrian, stimulus intensity of the stimulus pattern 2 is larger than stimulus intensity of the stimulus pattern 1.

Note that, the risk degree of the vehicle does not need to be higher than the risk degree of the pedestrian.

### Characteristics of Second Embodiment

The information indicating device 103 transmitting the stimulus information to the steering wheel 200 of the mobile object 100 including the steering wheel 200 that indicates the information to the driver based on the stimulus information corresponding to the stimulus, includes:

the grip detection unit 340 to receive from the steering wheel 200, the grip detection information regarding a contact state between the driver and the steering wheel 200, receive the pattern information from the pattern database 501 that stores the pattern information indicating a contact pattern between the steering wheel 200 and the palm and the like when the human grips the steering wheel 200, determine a part of the palm and the like by which the driver grips the steering wheel 200, based on the grip detection information and the pattern information, and generate the grip information including information on a part of the palm and the like; and

the stimulus generation unit 360 to, when the mobile object 100 and the obstacle around the mobile object 100 exist, generate based on the grip information, the stimulus information that tells the risk degree of the obstacle to the driver by stimulating the palm and the like.

The information indicating device 103 includes:

the obstacle detection unit 300 to receive from the mobile object 100, the environment information indicating the environment in the surroundings of the mobile object 100; and

the risk degree calculation unit 321 to, based on the environment information, detect the obstacle and calculate the risk degree of the obstacle, and

the stimulus generation unit 360 generates the stimulus information based on the grip information and the risk degree.

The stimulus generation unit 360 sets the stimulus corresponding to the stimulus information to a stimulus with intensity corresponding to the risk degree of the obstacle, which is a stimulus that stimulates a part of the hand of the driver which corresponds to an orientation relative to a traveling direction of the mobile object 100 which is an orientation in which the obstacle is located.

### Description of Effect of Second Embodiment

As described above, according to the present embodiment, it is possible to generate the stimulus information corresponding to the stimulus which causes the driver to sense the obstacle outside of the field of view even when the driver of the mobile object 100 looks in a different direction from the obstacle during the driving of the mobile object 100.

Further, according to the present embodiment, by associating the orientation of the obstacle relative to the mobile object 100 with a part of the palm and the like, and setting the stimulus intensity as something corresponding to the risk degree of the obstacle, it is possible to generate the stimulus information that is not only the driver can sense existence of the obstacle but also corresponding to the stimulus that causes the driver to intuitively sense the orientation and the risk degree of the obstacle.

Therefore, according to the present embodiment, it is possible to not only warn the driver of the mobile object 100 that the obstacle approaches the mobile object 100 but also generate the stimulus information corresponding to the stimulus that warns specifically which direction the obstacles is and how close the obstacle gets.

### Sixteenth Modification Example

The information indicating device 103 does not need to include the risk degree calculation unit 321.

In the present modification example, the information indicating device 103

may acquire the risk degree information via the communication unit 380, and

transmit to the outside via the communication unit 380, information required to generate the risk degree information.

### Seventeenth Modification Example

When there are a plurality of obstacles, the stimulus generation unit 360 may generate the stimulus information that stimulates all the stimulus places corresponding to the obstacle in order.

### Other Embodiments

It is possible to freely combine each of the above-described embodiments, modify any component of each embodiment, or omit any component in each embodiment.

Further, the embodiment is not limited to the ones described in the first and second embodiments, and various modifications can be made as necessary.

### REFERENCE SIGNS LIST

10: processor, 11: memory, 12: storage device, 13: communication IF, 16: SW, 17: electronic circuit, 19: OS, 100: mobile object, 101: environment detection sensor, 102: state detection sensor, 103: information indicating device, 200: steering wheel, 201: tactile sensation indicating device, 202: grip detection sensor, 300: obstacle detection unit, 310: track prediction unit, 320: risk determination unit, 321: risk degree calculation unit, 330: track calculation unit, 340: grip detection unit, 350: stimulus generation unit, 351: position adjustment unit, 352: pattern generation unit, 353: position decision unit, 360: stimulus generation unit, 380: communication unit, 390: recording unit, 501: pattern DB (pattern database).

1. An information indicating device transmitting stimulus information to a steering wheel of a mobile object including the steering wheel that indicates information to a driver based on the stimulus information corresponding to a stimulus, comprising:
processing circuitry
to receive from the steering wheel, grip detection information regarding a contact state between the driver and the steering wheel, receive pattern information from a pattern database that stores the pattern information in which parts of a hand are linked to an intensity distribution indicating intensity of a physical phenomenon which is an intensity distribution generated on a bar-shaped object when a human grips the bar-shaped object by using a palm and the like, determine a part of the palm and the like by which the driver grips the steering wheel, based on the grip detection information and the pattern information, and generate grip information including information on the part of the palm and the like; and
to, when there is a possibility that the mobile object contacts with an obstacle that is located around the mobile object, generate based on the grip information, the stimulus information that leads the driver to avoid the obstacle by stimulating the palm and the like.

2. The information indicating device according to claim 1,
wherein the processing circuitry
receives from the mobile object, environment information indicating an environment in surroundings of the mobile object, and
based on the environment information, detects the obstacle and determines whether or not there is a possibility that the mobile object and the obstacle contact with each other.

3. The information indicating device according to claim 1,
wherein the processing circuitry
receives from the mobile object, mobile object information including speed, acceleration, turning speed, and a steering angle of the mobile object, and generates track prediction information by predicting a track of the mobile object based on the mobile object information,
generates control information based on the track prediction information, and
generates the stimulus information based on the grip information and the control information.

4. The information indicating device according to claim 2,
wherein the processing circuitry
receives from the mobile object, mobile object information including speed, acceleration, turning speed, and a steering angle of the mobile object, and generates track prediction information by predicting a track of the mobile object based on the mobile object information,
generates control information based on the track prediction information, and
generates the stimulus information based on the grip information and the control information.

5. The information indicating device according to claim 1,
wherein the processing circuitry generates the stimulus information corresponding to a stimulus that generates apparent motion.

6. The information indicating device according to claim 2,
wherein the processing circuitry generates the stimulus information corresponding to a stimulus that generates apparent motion.

7. The information indicating device according to claim 3,
wherein the processing circuitry generates the stimulus information corresponding to a stimulus that generates apparent motion.

8. The information indicating device according to claim 4,
wherein the processing circuitry generates the stimulus information corresponding to a stimulus that generates apparent motion.

9. The information indicating device according to claim 5,
wherein the processing circuitry leads the driver to turn the steering wheel to right by setting the stimulus corresponding to the stimulus information to a stimulus that stimulates a left hand and a right hand of the driver alternately, which is a stimulus that stimulates bases of a fifth finger to a second finger of the left hand of the driver one by one in order, which is a stimulus that stimulates bases of a second finger to a fifth finger of the right hand of the driver one by one in order, which is a stimulus that changes at a certain interval, a part to stimulate.

10. The information indicating device according to claim 6,
wherein the processing circuitry leads the driver to turn the steering wheel to right by setting the stimulus corresponding to the stimulus information to a stimulus that stimulates a left hand and a right hand of the driver alternately, which is a stimulus that stimulates bases of a fifth finger to a second finger of the left hand of the driver one by one in order, which is a stimulus that stimulates bases of a second finger to a fifth finger of the right hand of the driver one by one in order, which is a stimulus that changes at a certain interval, a part to stimulate.

11. The information indicating device according to claim 7,
wherein the processing circuitry leads the driver to turn the steering wheel to right by setting the stimulus corresponding to the stimulus information to a stimulus that stimulates a left hand and a right hand of the driver alternately, which is a stimulus that stimulates bases of a fifth finger to a second finger of the left hand of the driver one by one in order, which is a stimulus that stimulates bases of a second finger to a fifth finger of the right hand of the driver one by one in order, which is a stimulus that changes at a certain interval, a part to stimulate.

12. The information indicating device according to claim 8,
wherein the processing circuitry leads the driver to turn the steering wheel to right by setting the stimulus corresponding to the stimulus information to a stimulus that stimulates a left hand and a right hand of the driver alternately, which is a stimulus that stimulates bases of a fifth finger to a second finger of the left hand of the driver one by one in order, which is a stimulus that stimulates bases of a second finger to a fifth finger of the right hand of the driver one by one in order, which is a stimulus that changes at a certain interval, a part to stimulate.

13. An information indicating device transmitting stimulus information to a steering wheel of a mobile object including the steering wheel that indicates information to a driver based on the stimulus information corresponding to a stimulus, comprising:
processing circuitry
to receive from the steering wheel, grip detection information regarding a contact state between the driver and the steering wheel, receive pattern information from a pattern database that stores the pattern information in which parts of a hand are linked to an intensity distribution indicating intensity of a physical phenomenon which is an intensity distribution generated on a bar-shaped object when a human grips the bar-shaped object by using a palm and the like, determine a part of the palm and the like by which the driver grips the steering wheel, based on the grip detection information and the pattern information, and generate grip information including information on the part of the palm and the like; and
to, when the mobile object and an obstacle around the mobile object exist, generate based on the grip information, the stimulus information that tells a risk degree of the obstacle to the driver by stimulating the palm and the like.

14. The information indicating device according to claim 13,
wherein the processing circuitry
receives from the mobile object, environment information indicating an environment in surroundings of the mobile object,
based on the environment information, detects the obstacle and calculates a risk degree of the obstacle, and
generates the stimulus information based on the grip information and the risk degree.

15. The information indicating device according to claim 13,
wherein the processing circuitry sets a stimulus corresponding to the stimulus information to a stimulus with intensity corresponding to the risk degree of the obstacle, which is a stimulus that stimulates a part of a hand of the driver which corresponds to an orientation relative to a traveling direction of the mobile object which is an orientation in which the obstacle is located.

16. The information indicating device according to claim 14,
wherein the processing circuitry sets a stimulus corresponding to the stimulus information to a stimulus with intensity corresponding to the risk degree of the obstacle, which is a stimulus that stimulates a part of a hand of the driver which corresponds to an orientation relative to a traveling direction of the mobile object which is an orientation in which the obstacle is located.

17. An information indicating method used by an information indicating device transmitting stimulus information to a steering wheel of a mobile object including the steering wheel that indicates information to a driver based on the stimulus information corresponding to a stimulus, comprising:
by a grip detection unit,
receiving from the steering wheel, grip detection information regarding a contact state between the driver and the steering wheel;
receiving pattern information from a pattern database that stores the pattern information in which parts of a hand are linked to an intensity distribution indicating intensity of a physical phenomenon which is an intensity distribution generated on a bar-shaped object when a human grips the bar-shaped object by using a palm and the like;
determining a part of the palm and the like by which the driver grips the steering wheel, based on the grip detection information and the pattern information, and generate grip information including information on the part of the palm and the like; and
by a stimulus generation unit,
when there is a possibility that the mobile object contacts with an obstacle that is located around the mobile object, generating based on the grip information, the stimulus information that leads the driver to avoid the obstacle by stimulating the palm and the like.

18. A non-transitory computer readable medium storing an information indicating program which causes a computer, which is an information indicating device transmitting stimulus information to a steering wheel of a mobile object including the steering wheel that indicates information to a driver based on the stimulus information corresponding to a stimulus, to:
receive from the steering wheel, grip detection information regarding a contact state between the driver and the steering wheel;
receive pattern information from a pattern database that stores the pattern information in which parts of a hand are linked to an intensity distribution indicating intensity of a physical phenomenon which is an intensity distribution generated on a bar-shaped object when a human grips the bar-shaped object by using a palm and the like;
determine a part of the palm and the like by which the driver grips the steering wheel, based on the grip detection information and the pattern information, and generate grip information including information on the part of the palm and the like; and
when there is a possibility that the mobile object contacts with an obstacle that is located around the mobile object, generate based on the grip information, the stimulus information that leads the driver to avoid the obstacle by stimulating the palm and the like.

19. An information indicating method used by an information indicating device transmitting stimulus information to a steering wheel of a mobile object including the steering wheel that indicates information to a driver based on the stimulus information corresponding to a stimulus, comprising:
by a grip detection unit,
receiving from the steering wheel, grip detection information regarding a contact state between the driver and the steering wheel;
receiving pattern information from a pattern database that stores the pattern information in which parts of a hand are linked to an intensity distribution indicating intensity of a physical phenomenon which is an intensity distribution generated on a bar-shaped object when a human grips the bar-shaped object by using a palm and the like;
determining a part of the palm and the like by which the driver grips the steering wheel, based on the grip detection information and the pattern information, and generate grip information including information on the part of the palm and the like; and
by a stimulus generation unit,
when the mobile object and an obstacle around the mobile object exist, generating based on the grip information, the stimulus information that tells a risk degree of the obstacle to the driver by stimulating the palm and the like.

20. A non-transitory computer readable medium storing an information indicating program which causes a computer, which is an information indicating device transmitting stimulus information to a steering wheel of a mobile object including the steering wheel that indicates information to a driver based on the stimulus information corresponding to a stimulus, to:
receive from the steering wheel, grip detection information regarding a contact state between the driver and the steering wheel;
receive pattern information from a pattern database that stores the pattern information in which parts of a hand are linked to an intensity distribution indicating intensity of a physical phenomenon which is an intensity distribution generated on a bar-shaped object when a human grips the bar-shaped object by using a palm and the like;
determine a part of the palm and the like by which the driver grips the steering wheel, based on the grip detection information and the pattern information, and generate grip information including information on the part of the palm and the like; and
when the mobile object and an obstacle around the mobile object exist, generate based on the grip information, the stimulus information that tells a risk degree of the obstacle to the driver by stimulating the palm and the like.
